(19) United States
(12) Patent Application Publication
(10) Pub. No.: US 2021/0324142 A1
(43) Pub. Date: Oct. 21, 2021

(54) CROSS-LINKED POLYIMIDE MEMBRANES AND CARBON MOLECULAR SIEVE HOLLOW FIBER MEMBRANES MADE THEREFROM

(71) Applicants: Dow Global Technologies LLC, Midland, MI (US); Georgia Tech Research Corporation, Atlanta, GA (US)

(72) Inventors: Justin T. Vaughn, Medford, MA (US); Wulin Qiu, Snellville, GA (US); William J. Koros, Atlanta, GA (US); Liren Xu, Spring, TX (US); Mark K. Brayden, Plaquemine, LA (US)

(73) Assignees: Dow Global Technologies LLC, Midland, MI (US); Georgia Tech Research Corporation, Atlanta, GA (US)

(21) Appl. No.: 17/266,778

(22) PCT Filed: Aug. 20, 2019
(86) PCT No.: PCT/US2019/047132

§ 371 Date: Feb. 8, 2021

Related U.S. Application Data
(60) Provisional application No. 62/721,750, filed on Aug. 23, 2018.

(51) Int. Cl. C08G 73/10; B01D 53/22; B01D 67/00; B01D 69/08; B01D 69/14; B01D 71/02

(52) U.S. Cl. CPC C08G 73/1042; B01D 53/228; B01D 67/0067; B01D 69/08; B01D 69/141; B01D 71/021; B01D 2325/04; C08G 73/1075; B01D 2257/702; B01D 2256/16; B01D 2323/08; B01D 2323/14; C08G 73/101

(57) ABSTRACT

A cross-linked polyimide of the reaction product of a crosslinking agent and a polyimide. The cross-linking agent having at least two cross-linking moieties and the polyimide has a plurality of polyimide chains having an aryl constituent with a moiety comprised of a reactive substituent. The polyimide has crosslinks from the reaction of the reactive substituent of the aryl constituents of the polyimide chains and the cross-linking moieties of the cross-linking agent. The cross-linking may be induced by thermally treating a mixture of the polyimide and crosslinking agent above about 150° C. to a temperature where the polyimide begins to decompose under an inert atmosphere. The membrane can be used for separations involving gases such as hydrogen and light hydrocarbons.

### CROSS REFERENCE TO RELATED APPLICATION

This application claims priority to U.S. Provisional Patent Application No. 62/721,750 filed on Aug. 23, 2018, the entire disclosure of which is hereby incorporated by reference.

### FIELD OF THE INVENTION

The invention relates to polyimide membranes useful for making carbon molecular sieve (CMS) membranes that may be used to separate gases. In particular the invention relates to a method for producing cross-linked polyimide membranes that can be pyrolyzed to form CMS membranes.

### BACKGROUND OF THE INVENTION

Membranes are widely used for the separation of gases and liquids, including for example, separating acid gases, such as CO₂ and H₂S from natural gas, and the removal of O₂ from air. Gas transport through such membranes is commonly modeled by the sorption-diffusion mechanism. Currently, polymeric membranes are well studied and widely available for gaseous separations due to easy process-ability and low cost. CMS membranes, however, have been shown to have attractive separation performance properties exceeding that of polymeric membranes.

Polyimides have been pyrolyzed to form CMS membranes under many differing conditions. U.S. Pat. No. 6,565,631 discloses pyrolyzing under vacuum and inert gases with trace amounts of oxygen. Other patents describe processes for producing carbon membranes (both asymmetric hollow “filamentary” and flat sheets), and applications for gas separation, include, for example, U.S. Pat. No. 5,288,304 and EP Patent No. 0459623. Steel and Koros performed a detailed investigation of the impact of pyrolysis temperature, thermal soak time, and polymer composition on the performance of carbon membranes. (K. M. Steel and W. J. Koros, Investigation of Porosity of Carbon Materials and Related Effects on Gas Separation Properties, Carbon, 41, 253 (2003); K. M. Steel and W. J. Koros, An Investigation of the Effects of Pyrolysis Parameters on Gas Separation Properties of Carbon Materials, Carbon, 43, 1843 (2005)). In these works membranes were produced in an air atmosphere at 0.03 mm Hg pressure.

The impact of pyrolysis atmosphere has been researched. Suda and Haraya disclosed the formation of CMS membranes under different environments. (H. Suda and K. Haraya, Gas Permeation Through Micropores of Carbon Molecular Sieve Membranes Derived From Kapton Polyimide, J. Phys. Chem. B, 101, 3988 (1997).) Similarly, Geiszler and Koros disclosed the results of CMS fibers produced from pyrolysis of fluorinated polyimide in helium and argon for both O₂/N₂ and H₂/N₂ separations. (V. C. Geiszler and W. J. Koros, Effects of Polyimide Pyrolysis Atmosphere on Separation Performance of Carbon Molecular Sieve Membranes, Ind. Eng. Chem. Res., 35, 2999 (1996)).

When making asymmetric hollow fibers CMS membranes from polyimides, which have a thin dense separating layer and thick inner porous support structure, it has been difficult to make the hollow fibers without having undesired structural collapse. Structural collapse results in an undesired thicker separating layer resulting in poor permeance of desired permeate gases rendering the fibers commercially impractical. (see L. Xu, et al. Journal of Membrane Science, 380 (2011), 138-147).

To address this problem, complicated involved methods have been described such as in U.S. Pat. No. 9,211,504. In this patent, the application of a sol-gel silica that undergoes cross-linking on the inner porous walls of the polyimide is described to reduce the structural collapse during pyrolysis to form the hollow fiber CMS membrane. Recently, WO/2016/048612 describes a separate particular preoxidation of particular polyimides, such as 6FDA/BPDA-DAM, having the stoichiometry shown in Formula 1. Formula 1 shows a chemical structure for 6FDA/BPDA-DAM where X and Y are each 1 so as to provide a 1:1 ratio.

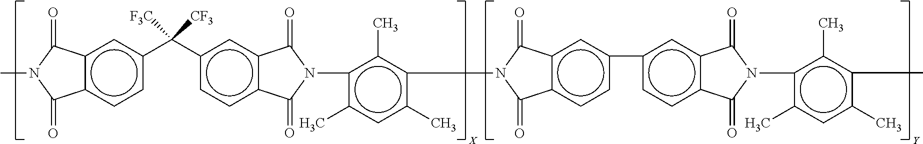

This polyimide after undergoing the pre-oxidation was reported to decrease the structural collapse and reduce sticking of the fibers during and after pyrolysis.

It also has been reported that a particular polyimide referred to 6FDA-DAM/DABA (3:2) as shown below, that undergoes cross linking by decarboxylation through the DABA moiety, also decreased structural collapse, but resulted in undesirably low permeances for low molecular olefins making them unsuitable for separation of these from their corresponding paraffins. (Xu, Liren, Ph.D. Thesis Dissertation, Carbon Molecular Sieve Hollow Fiber Membranes for Olefin/paraffin Separations, Georgia Tech. Univ., 2014, pages 136-138 and 142).

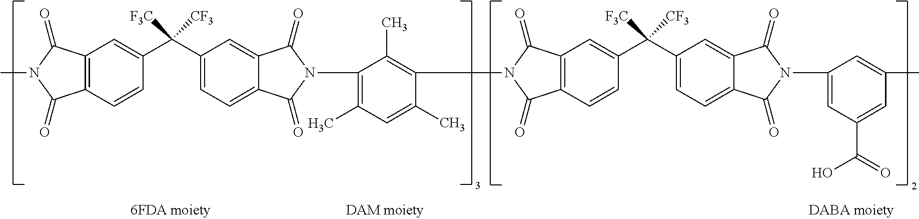

However, a subsequent study reported that cross-linking MATRAMID polyimide asymmetric hollow fiber using a diamine cross-linking compound failed to reduce the structural collapse of the separating layer of the hollow fiber. (Bhuwania, Nitesh, Ph.D. Thesis Dissertation. (2015). Engineering the Morphology of Carbon Molecular Sieve (CMS) Hollow Fiber Membranes, Georgia Tech. Univ. 2015, pages 184-187).

It would be desirable to provide a polyimide membrane and a method of making the polyimide membrane as well as a method to pyrolyze the polyimide to form a CMS membrane that avoids any one of the problems mentioned above. For example, it would be desirable to provide a method that did not involve any further process steps involving heat-treatments or treatments prior to pyrolysis of the polyimide membrane to form a carbon molecular sieve membrane. It would also be desirable for the CMS membrane to not exhibit, structural collapse while still having sufficient permeance to effectively separate valuable light hydrocarbons such as ethylene, propylene and butylene from their corresponding paraffins.

### SUMMARY OF THE INVENTION

A first aspect of the invention is a cross-linked polyimide comprising, the reaction product of a crosslinking agent and a polyimide, wherein the cross-linking agent is comprised of at least two cross-linking moieties and the polyimide is comprised of two or more polyimide chains having an aryl constituent having a moiety comprised of a reactive substituent (e.g., reactive hydrogen) such that the polyimide chains are cross-linked through the cross-linking agent by cross-linking chemical bonds from the reaction of the reactive substituent of the aryl constituents of the polyimide chains and the cross-linking moieties of the cross-linking agent.

A second aspect of the present invention is a method of forming a cross-linked polyimide comprising,
(i) mixing a cross-linking agent comprised of a plurality of cross-linking moieties and a polyimide that is comprised of a plurality of polyimide chains having an aryl constituent having a moiety comprised of a reactive substituent to form a mixture and
(ii) heating the mixture to a cross-linking temperature that is greater than 150° C. to a pyrolysis temperature, which is a temperature where the polyimide begins to decompose and form carbon, to react the reactive substituent with the cross-linking moiety to form the cross-linked polyimide.

A third aspect of the present invention is a method of forming a carbon molecular sieve membrane comprising, heating the cross-linked polyimide of the first or second aspect to a pyrolysis temperature of 450° C. to 1200° C. for a time or at least 15 minutes to 72 hours under a nonoxiding atmosphere.

A fourth aspect of the invention is a carbon molecular sieve membrane, comprised of carbon and a halogen at a concentration of 10 to 2000 parts per million by weight of the carbon molecular sieve membrane.

The crosslinked polyimide of the invention allows the realization of a useful CMS asymmetric membrane for separating gases. In particular the crosslinked polyimide of allows for the production of an asymmetric CMS membrane such as an asymmetric hollow fiber CMS membrane have reduced or no structural collapse of the separation layer, which can result in improved combinations of selectivity and permeance for desired gas pairs. Illustratively, the method allows for CMS membrane having good selectivity for similar sized gas molecules (e.g., hydrogen/ethylene; ethylene/ethane; propylene/propane and butylene/butane) while still having higher permeance of the target permeate gas molecule (e.g., hydrogen in gases containing hydrogen/ethylene). That is, the selectivity/permeance characteristics (productivity) are substantially improved relative to CMS asymmetric hollow fiber membranes made using polyimides in the absence of crosslinking.

CMS membranes of the present invention are particularly useful for separating gas molecules in gas feeds that have very similar molecular sizes such as hydrogen/ethylene and ethylene/ethane. It may also be used to separate gases from atmospheric air such as oxygen or separating gases (e.g., methane) in natural gas feeds.

### DETAILED DESCRIPTION OF THE INVENTION

The cross-linked polyimide is formed by reacting a polyimide polymer with a cross-linking agent having at least two cross-linking moieties. The polyimide is comprised of a plurality of polyimide chains having an aryl constituent having a moiety comprised of a reactive substituent that reacts with the cross-linking moieties of the cross-linking agent. The reactive substituent may be a reactive hydrogen or halogen contained in an alkyl, amino, amide, ether, carboxylic acid or hydroxyl appended to the aryl constituent of the polyimide. Preferably, the reactive constituent is a hydrogen present in an alkyl appended to an aryl group in the polyimide. Preferably the alkyl is a methyl group and the aryl is a benzene ring.

Exemplary polyimides may include any of the aromatic polyimide described by U.S. Pat. No. 4,983,191 from col. 2, line 65 to col. 5, line 28 that have the aforementioned reactive substituent. Other aromatic polyimides that may be used are described by U.S. Pat. Nos. 4,717,394; 4,705,540; and re30351 that have said reactive substituent. Generally, suitable aromatic polyimides typically are a reaction product of a dianhydride and a diamine, which is understood to proceed by forming a polyamic acid intermediate that is subsequently ring-closed to form the polyimide by chemical and/or thermal dehydration. Desirably, the polyimide is formed from a diamine that has an active hydrogen moiety substituted on an aryl after formation of the polyimide Desirable polyimides typically contain at least two different moieties selected from 2,4,6-trimethyl-1,3-phenylene diamine (DAM), dimethyl-3,7-diaminodiphenyl-thiophene-5,5′-dioxide (DDBT), 3,5-diaminobenzoic acid (DABA), 2,3,5,6-tetramethyl-1,4-phenylene diamine (durene), tetramethylmethylenedianaline (TMMDA), 4,4′-diamino 2,2′-biphenyl disulfonic acid (BDSA); 5,5′-[2,2,2-trifluoro-1-(trifluoromethyl)ethylidene]-1,3-isobenzofurandion (6FDA), 3,3′,4,4′-biphenyl tetracarboxylic dianhydride (BPDA), pyromellitic dianhydride (PMDA), 1,4,5,8-naphthalene tetracarboxylic dianhydride (NTDA), and benzophenone tetracarboxylic dianhydride (BTDA), with two or more of 6FDA, BPDA and DAM being preferred. In another embodiment, the polyimide is formed from at least one of the following diamines: is 2,4,6-trimethyl-1,3-phenylenediamine (DAM), 3,5-diaminobenzoic acid (DABA), 2,3,5,6-tetramethyl-1,4-phenylenediamine (durene), or tetramethylmethylenedianiline (TMMDA).

In a particular embodiment the polyimide is one that is designated 6FDA/BPDA-DAM. It may be synthesized via thermal or chemical processes from a combination of three monomers: DAM; 6FDA, and BPDA, each commercially available for example from Sigma-Aldrich Corporation. The below chemical structure represents 6FDA/BPDA-DAM, with a potential for adjusting the ratio between X and Y to tune polymer properties. As used in examples below, a 1:1 ratio of component X and component Y may also abbreviated as 6FDA/BPDA(1:1)-DAM.

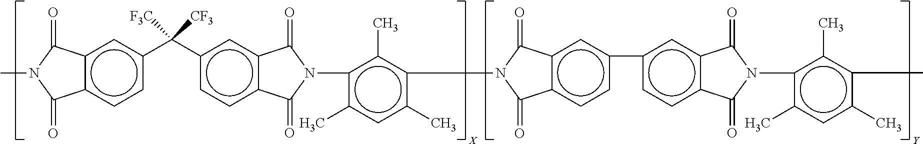

A second particular polyimide embodiment, designated as 6FDA-DAM, lacks BPDA such that Y equals zero in Formula 1 above. The below chemical structure below shows represents the polyimide.

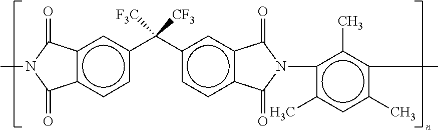

Generally, the polyimide has a molecular weight sufficient to form a polyimide membrane such as a hollow fiber having the requisite strength to be handled and subsequently pyrolyzed, but not so high that it becomes impractical to dissolve to make a dope solution able to form the hollow fiber. Typically, the weight average (M_{w}) molecular weight of the polyimide is 30 to 200 kDa, but desirably the molecular weight of 40 to 100 kDa. Polymer molecular weight may be controlled by stoichiometry of dianhydride to diamine monomers, monomer purity, as well as use of monofunctional endcapping agents such as monoamines (i.e., aniline, 3-ethynylaniline) and monoanhydrides (i.e., phthalic anhydride, succinic anhydride, maleic anhydride).

The cross-linking agent may be any compound that contains at least two cross linking moieties to cross-link the polyimide chains and is soluble in like solvents to enable sufficient molecular mixing to carry out the cross-linking so that the membrane that is formed has the cross-linking agent homogeneously dispersed within the polyimide. The cross-linking agent may be a linear, branched, cyclic non-aromatic compound or it may be an aromatic compound. Preferably, the cross-linking agent is comprised of cyclic or aromatic rings with the aromatic rings preferably being benzene rings. Generally, the molecular weight of the cross-linking agent is from 50 to 50,000, but desirably the molecular weight is from 250, 500, 700 or 1000 to 40,000, 25,000, 10,000 or 5000.

The cross-linking moieties of the cross-linking agent may be any that reacts with the reactive hydrogen of the polyimide such as halogens, carboxylic acids, or alcohols, upon heating up to the pyrolysis temperature with or without a catalyst such as those described for the reactive substituent in the polyimide. Preferably the cross-linking moiety is a halogen. Preferably the halogen is bromine. It is believed, but in no way limiting, that the reaction is desirably close to the glass transition temperature and up to the pyrolysis temperature. This typically means the cross-linking occurs at a temperature near the glass transition temperature of the polyimide. Near means within about 50° C. of the glass transition temperature. This generally means the cross-linking temperature is above about 250° C. or 300° C. to about 450° C. or 400° C.

In a particular embodiment, the cross-linking agent is an aromatic epoxide having a halogen. Preferably, the halogen compound has at least one bromine and even more preferably, all of the halogens in the halogen compound are bromines. Illustratively the aromatic epoxide is an oligomeric or polymeric residue having at least two halogen substituents represented by:

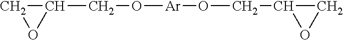

where Ar represents a divalent aromatic group of the form:

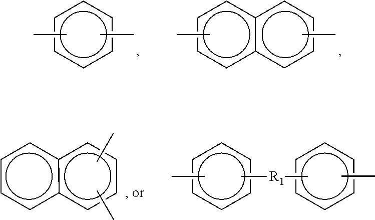

where R₁ is a direct bond or anyone of the following divalent radicals:

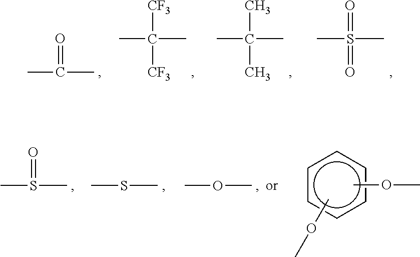

where Ar is substituted with at least two halogens.
Desirably the halogens are bromine. In a particular embodiment, each aromatic ring of the aromatic epoxide is substituted with a halogen ortho to the glycidyl ether end groups of the aforementioned. A particular aromatic epoxide is an oligomer or polymer having repeating units represented by:

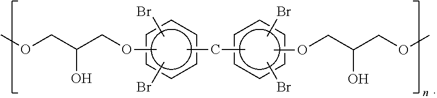

The value of n may be any value, but generally is a value that realizes the aforementioned molecular weight for the aromatic epoxide described above.

The cross-linked polyimide may be formed by thermal induced cross-linking with or without a catalyst. Illustratively, the cross-linked polyimide is formed by a method comprising mixing a polyimide that has been formed from a diamine that has a reactive substituent (e.g., hydrogen) in a moiety (e.g., alkyl) substituted on an aryl after formation of the polyimide and cross-linking with a cross-linking agent comprised of at least two halogens followed by heating to a cross-linking temperature that is at least 150° C. to the pyrolysis temperature of the cross-linked polyimide. The pyrolysis temperature is a temperature where the polyimide begins to decompose and form carbon. At the cross-linking temperature, in the above illustration, the halogens react with the hydrogen to form a byproduct acid and cross-link chemical bond with the cross-linking agent. The bond that forms should not or does not undergo rescission prior to decomposition of the polyimide under an inert atmosphere (i.e., pyrolysis temperature which is typically about 400° C.).

To mix the polyimide and the crosslinking agent, typically they are dissolved into a solvent and formed into a useful shape such as a thin membrane or hollow fiber. Illustratively, conventional procedures known in the art may be used (see, for example U.S. Pat. Nos. 5,820,659; 4,113,628; 4,378,324; 4,460,526; 4,474,662; 4,485,056; 4,512,893 and 4,717,394). Exemplary methods include coextrusion procedures including such as a dry-jet wet spinning process (in which an air gap exists between the tip of the spinneret and the coagulation or quench bath) or a wet spinning process (with zero air-gap distance) may be used to make the hollow fibers.

To make the polyimide crosslinking agent dispersed homogeneously therein a dope solution is used comprised of the polyimide, crosslinking agent and solvents. Typically, when making a thin film membrane a dope solution comprised of a solvent that dissolves the polyimide and crosslinking agent is used, for example, when casting onto a flat plate and the solvent removed. When making a hollow fiber, typically a dope solution that is a mixture of a solvent that solubilizes the polyimide and a second solvent that does not solubilize (or to a limited extent solubilizes) the polyimide, but is soluble with the solvent that solubilizes the polyimide are used. Exemplary solvents that are useful to solubilize the polyimide include N-Methyl-2-pyrrolidone (NMP), tetrahydrofuran (THF), dimethylacetamide (DMAc) and dimethylformamide (DMF). Exemplary solvents that do not solubilize the polyimide, but are soluble with the solvents that do solubilize the polyimide include methanol, ethanol, water, and 1-propanol.

The amount of the crosslinking agent used may be any suitable amount to realize sufficient crosslinking of the polyimide to realize a useful trait, for example, of a subsequently formed CMS membrane such as described below. Generally, the amount of crosslinking agent is from about 0.1% to 10% by weight of the mixture of the polyimide and crosslinking agent. More typically the amount of crosslinking agent is about 0.2%, 0.5% or 1% to about 10%, 5% or 3% by weight of the polyimide and crosslinking agent.

After the dope solution is formed, the solution is shaped, for example, into a hollow fiber as described above. After shaping, the solvents may be exchanged with other solvents (such as methanol and hexane) to prevent, for example, pore collapse, and the solvents are further removed by any convenient method such as application of heat, vacuum, flowing gases or combination thereof and include those known in the art.

After removing the solvent, the shaped membrane such as the hollow fiber is heated to a crosslinking temperature sufficient to crosslink the polyimide, which is a temperature of at least 150° C. to a pyrolysis temperature (about 400° C.). The crosslinking temperature is desirably of 200° C., 250° C. or 300° C. to 375° C. or 350° C. The amount of time at the crosslinking temperature may be any amount of time sufficient to crosslink the polyimide such that it improves, for example, useful properties such as minimizing or eliminating separation layer collapse when forming a hollow carbon molecular sieve (CMS) membrane as described below. In an embodiment, the time at the crosslinking temperature is held at a particular temperature described above for a period of time from 5 to 10 minutes to 24 hours, 10 hours, 5 hours, 2 hours or 1 hour and then cooled to room temperature. In another embodiment, the rate of heating during the pyrolysis to form a CMS membrane may be moderated or slowed where crosslinking occurs to realize sufficient crosslinking of the polyimide prior to the pyrolysis temperature. When making a CMS membrane, it is desirable that the crosslinking is realized by using a hold temperature described above.

It has been discovered that the crosslinked polyimide hollow fibers enables the formation of a carbon molecular sieve (CMS) that has a wall that is defined by an inner surface and outer surface of said fiber and the wall has an inner porous support region (support layer) extending from the inner surface to an outer microporous region (separation layer) that extends from the inner porous support region to the outer surface. Surprisingly, it has been discovered when the crosslinked polyimide is used, structural collapse of the inner porous support region may be avoided and the outer microporous separation layer may be tailored to be desirably thin in absence of any pretreatment of the polyimide fiber, for example, as described in PCT Publ. WO/2016/048612 or incorporation of an inorganic gel such as described in U.S. Pat. No. 9,211,504 described previously. Avoidance of structural collapse may be illustrated as follows. If the polyimide separation layer is about 0.3 to about 2 micrometers, the corresponding CMS fiber separation layer thickness may be 10, 8.75, 7.5, 6.25, 5.5, 4.25 or 3.0 micrometers or less.

To form a CMS membrane from the crosslinked polyimide, the crosslinked polyimide is pyrolyzed to form the CMS membrane. The crosslinked polyimide membrane, which is typically an asymmetric hollow fiber may be pyrolyzed under various inert gas purge or vacuum conditions, preferably under inert gas purge conditions, for the vacuum pyrolysis, preferably at low pressures (e.g., less than 0.1 millibar). U.S. Pat. No. 6,565,631 and co-pending U.S. provisional application 62/310,836 describe a suitable heating method for pyrolysis of the polyimide fibers to form the CMS hollow fibers, and each is incorporated herein by reference. A pyrolysis temperature of between about 450° C. to about 800° C. may advantageously be used. The pyrolysis temperature may be adjusted in combination with the pyrolysis atmosphere to tune the performance properties of the resulting CMS hollow fiber membrane. For example, the pyrolysis temperature may be 1000° C. or more. Optionally, the pyrolysis temperature is maintained between about 500° C. and about 650° C. The pyrolysis soak time (i.e., the duration of time at the pyrolysis temperature) may vary (and may include no soak time) but advantageously is between about 1 hour to about 10 hours, alternatively from about 2 hours to about 8 hours, alternatively from about 4 hours to about 6 hours. An exemplary heating protocol may include starting at a first set point of about 70° C., then heating to a second set point of about 250° C. at a rate of about 13.3° C. per minute, then heating to a third set point of about 535° C. at a rate of about 3.85° C. per minute, and then a fourth set point of about 550° C. at a rate of about 0.25° C. per minute. The fourth set point is then optionally maintained for the determined soak time. After the heating cycle is complete, the system is typically allowed to cool while still under vacuum or in a controlled atmosphere.

Typically, the outer separation layer has a thickness of at most 10% of the wall extending from the inner surface to the outer surface. The outer separation layer typically has a thickness of 0.05 micrometers to 10 micrometers, desirably 0.05 micrometers to 5 micrometers, more desirably 0.05 to 3 micrometer. Herein, microporous shall mean pores <2 nm in diameter; mesoporous shall mean 2-50 nm in diameter and macroporous shall mean >50 nm in diameter. The microstructure of the separation layer in CMS is generally characterized with microporous pores. The support layer is generally characterized by a microstructure where the pores are microporous, macroporous or both.

In one embodiment the pyrolysis utilizes a controlled purge gas atmosphere during pyrolysis in which low levels of oxygen are present in an inert gas. By way of example, an inert gas such as argon is used as the purge gas atmosphere. Other suitable inert gases include, but are not limited to, nitrogen, helium, or any combinations thereof. By using any suitable method such as a valve, the inert gas containing a specific concentration of oxygen may be introduced into the pyrolysis atmosphere. For example, the amount of oxygen in the purge atmosphere may be less than about 50 ppm (parts per million) O₂/Ar. Alternatively, the amount of oxygen in the purge atmosphere may be less than 40 ppm O₂/Ar. Embodiments include pyrolysis atmospheres with about 8 ppm, 7 ppm, or 4 ppm O₂/Ar.

After pyrolyzing, the CMS membrane that has formed is cooled to a temperature where no further pyrolysis occurs. Generally, this is a temperature where no decomposition products would be evolved from the precursor polymer and may vary from polymer to polymer. Generally, the temperature is 200° C. or less and typically the temperature is taken as 100° C., 50° C. or essentially typical ambient temperatures (20 to 40° C.). The cooling may be at any useful rate, such as passively cooling (e.g., turning off the power to furnace and allowing to cool naturally). Alternatively, it may be desirable to more rapidly cool such as using known techniques to realize faster cooling such as removing insulation, or using cooling fans or employment of water cooled jackets.

After cooling, the CMS hollow fiber membrane may be subjected to a further treatment, for example, to make the fiber more stable or improve particular permeance/selectivity for particular gases. Such further treatments are described in pending provisional U.S. application 62/268,556, incorporated herein by reference.

The crosslinked polyimide fiber enables the formation of an asymmetric hollow fiber CMS membrane absent the structural collapse described above and desirable separation of hydrogen from light hydrocarbons (e.g., olefins) or light hydrocarbon olefins from their corresponding paraffins with acceptable permeance (productivity). It is not understood why the CMS membranes formed from the crosslinked polyimides realizes these particular properties, but it may be due in part to the presence of a halogen in the CMS membrane and the effect of the crosslinking agent during the heating to pyrolyze the polyimide (perhaps immobilizing the polyimide chains prior to pyrolysis). The method typically results in a CMS membrane having a halogen concentration of halogen concentration of trace (above the detection limit ppm) to 0.2% by weight of the carbon molecular sieve membrane. Desirably, the halogen concentration is, 10, 20, 25, or 50 parts per million to 1000 ppm. As described above, the halogen is preferably comprised of Br and more desirably the halogen is essentially only Br. The amount of halogen may be determined by known techniques such as neutron activation analysis.

The gas permeation properties of a membrane can be determined by gas permeation experiments. Two intrinsic properties have utility in evaluating the separation performance of a membrane material: its “permeability,” a measure of the membrane's intrinsic productivity; and its “selectivity,” a measure of the membrane's separation efficiency. One typically determines “permeability” in Barrer (1 Barrer=10⁻¹⁰ [cm³ (STP) cm]/[cm² s cmHg], calculated as the flux (nᵢ) divided by the partial pressure difference between the membrane upstream and downstream (Δpᵢ), and multiplied by the thickness of the membrane (1).

$${P}_{i} = \frac{{n}_{i} l}{Δ {p}_{i}}$$

Another term, “permeance”, is defined herein as productivity of asymmetric hollow fiber membranes and is typically measured in Gas Permeation Units (GPU) (1 GPU=10⁻⁶ [cm³ (STP)]/[cm² s cmHg]), determined by dividing permeability by effective membrane separation layer thickness.

$$( \frac{{P}_{i}}{l} ) = \frac{{n}_{i}}{Δ {p}_{i}}$$

Finally, “selectivity” is defined herein as the ability of one gas's permeability through the membrane or permeance relative to the same property of another gas. It is measured as a unit less ratio.

$${∝}_{i / j} = \frac{{P}_{i}}{{P}_{j}} = \frac{( {P}_{i} / l )}{( {P}_{j} / l )}$$

In a particular embodiment, the asymmetric hollow CMS membrane produced by the method enables a carbon hollow fiber CMS membrane that has a permeance of at least 5 GPU for a target gas molecule (permeate) and a selectivity of at least 10. In particular embodiments the permeate/retentate gas molecule pairs may be ethylene/ethane, propylene/propane, butylene/butane, hydrogen/ethylene, carbon dioxide/methane, water/methane, oxygen/nitrogen, or hydrogen sulfide/methane. Illustratively, the feed gas generally is comprised of at least 50% of the permeate gas molecule (e.g., ethylene or propylene) and 25% of the retentate gas molecule (e.g., ethane or propane).

In a particular embodiment the CMS membrane produced has a permeance of at least 60 GPU for hydrogen (permeate) and a selectivity of at least 120 for hydrogen/ethylene. Desirably, in this embodiment the permeance is at least 80, 90 or even 100 GPU for hydrogen. Likewise, in this embodiment the selectivity is at least 125, 130 or 135 for hydrogen/ethylene.

The CMS membranes are particularly suitable for separating gases that are similar in size such as described above, which involves feeding a gas feed containing a desired gas molecule and at least one other gas molecule through the CMS membrane. The flowing of the gas results in a first stream having an increased concentration of the desired gas molecule and, a second stream having an increased concentration of the other gas molecule. The process may be utilized to separate any of the aforementioned gas pairs and in particular is suitable for separating ethylene and ethane or propylene and propylene. When practicing the process, the CMS membrane is desirably fabricated into a module comprising a sealable enclosure comprised of a plurality of carbon molecular sieve membranes that is comprised of at least one carbon molecular sieve membrane produced by the method of the invention that are contained within the sealable enclosure. The sealable enclosure has an inlet for introducing a gas feed comprised of at least two differing gas molecules; a first outlet for permitting egress of a permeate gas stream; and a second outlet for egress of a retentate gas stream.

### EXAMPLES

### Comparative Example 1

The CMS of Comparative Example 1 was made using 6FDA:BPDA-DAM (1:1) polymer. The 6FDA:BPDA-DAM was acquired from Akron Polymer Systems, Akron, Ohio Gel permeation chromatography was performed to evaluate the molecular weight. Tosoh TSKgel Alpha-M columns were used with 0.5 mL/min eluent of dimethylformamide (DMF) with 4 g/L lithium nitrate. Waters 2695 separation module/Viscotek TDA 302 interface/Waters 2414 RI detector was used as the detector and was at 40° C. The polymer was dissolved in DMF at 0.25 wt %, and the sample injection volume was 100 μL. Agilent PEO/PEG EasiCal standards was used for calibration. The polymer had a weight average molecular weight (M_{w}) of 83 kDa and polydispersity index (PDI) of 5.2. The polymer was dried under vacuum at 110° C. for 24 hours and then a dope was formed. The dope was made by mixing the 6FDA:BPDA-DAM polymer with solvents and compounds in Table 1 and roll mixed in a Qorpak™ glass bottle sealed with a polytetrafluoroethylene (TEFLON™) cap and a rolling speed of 5 revolutions per minute (rpm) for a period of about 3 weeks to form a homogeneous dope.

TABLE 1
Comparative Example 1 Dope formulation

| Dope Component | weight % | mass (g) |
|---|---|---|
| Comp. Ex. 1 Polyimide | 25 | 50 |
| NMP | 43 | 86 |
| THF | 10 | 20 |
| EtOH | 22 | 44 |

NMP = N-Methyl-2-pyrrolidone; THF = Tetrahydrofuran; EtOH = Ethanol

The homogeneous dope was loaded into a 500 milliliter (mL) syringe pump and allowed to degas overnight by heating the pump to a set point temperature of 50° C. using a heating tape.

Bore fluid (80 wt % NMP and 20 wt % water, based on total bore fluid weight) was loaded into a separate 100 mL syringe pump and then the dope and bore fluid were co-extruded through a spinneret operating at a flow rate of 100 milliliters per hour (mL/hr) for the dope, and 100 mL/hr for the bore fluid, filtering both the bore fluid and the dope in line between delivery pumps and the spinneret using 40 μm and 2 μm metal filters. The temperature was controlled using thermocouples and heating tape placed on the spinneret, dope filters and dope pump at a set point temperature of 70° C.

After passing through a five centimeter (cm) air gap, the nascent fibers that were formed by the spinneret were quenched in a water bath (50° C.) and the fibers were allowed to phase separate. The fibers were collected using a 0.32 meter (m) diameter polyethylene drum passing over TEFLON guides and operating at a take-up rate of 5 meters per minute (m/min).

The fibers were cut from the drum and rinsed at least four times in separate water baths over a span of 48 hours. The rinsed fibers in glass containers and effect solvent exchange three times with methanol for 20 minutes and then hexane for 20 minutes before recovering the fibers and drying them under argon purge at a set point temperature of 100° C. for two hours.

Prior to pyrolyzing the fibers, a sample quantity of the above fibers (also known as “precursor fibers”) were tested for skin integrity. One or more hollow precursor fibers were potted into ¼ inch (0.64 cm) (outside diameter, OD) stainless steel tubing. Each tubing end was connected to a ¼ inch (0.64 cm) stainless steel tee; and each tee was connected to ¼ inch (0.64 cm) female and male NPT tube adapters, which were sealed to NPT connections with epoxy. The membrane modules were tested using a constant pressure permeation system. Argon was used as sweep gas in the permeate side. The flow rate of the combined sweep gas and permeate gas was measured by a Bios Drycal flowmeter, while the composition was measured by gas chromatography. The flow rate and composition were then used for calculating gas permeance. The selectivity of each gas pair as a ratio of the individual gas permeance was calculated. The mixed gas feed used for precursor defect-free property examination was 10 mol % CO₂/90 mol % N₂. The permeation unit was maintained at 35° C., and the feed and permeate/sweep pressures were kept at 52 and 2 psig, respectively.

The hollow fibers were pyrolyzed to form the CMS membranes by placing the precursor fibers on a stainless steel wire mesh plate each of them bound separately to the plate using stainless steel wire or in a bundle containing multiple hollow fibers contacting each other. The combination of hollow fibers and mesh plate were placed into a quartz tube that sits in a tube furnace. The fibers were pyrolyzed under an inert gas (argon flowing at a rate of 200 standard cubic centimeters per minute (sccm)). Prior to pyrolyzing the furnace was purged of oxygen by evacuating and then purging the tube furnace for a minimum of six hours to reduce the oxygen level to less than 5 ppm. All of the fibers were preheated to 70° C. at a ramp rate of 2° C./min, then heated to 250° C. at a ramp rate of 13.3° C./min, followed by heating to 660° C. at a ramp rate of 3.85° C./min, and to 675° C. at 0.25° C./min, finally soak at 675° C. for 2 hours. After the soak time, the furnace was shut off, cooled under the flowing argon (passively cooled), which typically cooled in about 4 to 6 hours.

After cooling the fibers were left to sit under the inert gas stream for 24 hours to allow the newly formed CMS to stabilize. The fibers after pyrolysis were stuck together and had to be carefully separated prior to any gas separation testing.

For module making and permeation tests, the fibers that were separated on the mesh prior to pyrolysis were used. Afterwards they were removed from the furnace and potted into modules as described above. The modules were allowed at least 2 hours to set before being loaded into the permeation testing system for initial tests. All permeation tests were determined using a 50:50 mixture of hydrogen and ethylene in a constant pressure system described above with 52 psig upstream and downstream at 2 psig argon purge at 35° C. The stage cut was maintained at less than 1%. For stable performance, the membranes were allowed to sit in the lab for at least 3 months and tested for stable performance. For each test, the permeation was run multiple hours and most of time more than 20 hours. The permeance and selectivity results are shown in Table 3.

### Example 1

In Example 1, brominated epoxy oligomer F-2016 was used as the cross-linking agent. The dope formulation is listed in Table 2. The spinning conditions were the same as Comparative Example 1 except that the spinneret temperature was 50° C., the quench bath temperature was 35.4° C., and the air gap was 15 centimeters.

After fiber spinning, solvent exchange, and fiber drying, the fibers were pyrolyzed under the same 675° C. protocol used in Comparative Example 1 and tested for hydrogen/ethylene separation. The permeance and selectivity results are shown in Table 3.

TABLE 2
Example 1 Dope formulation

| Dope Component | weight % | mass (g) |
|---|---|---|
| Ex. 1 Polyimide | 22 | 44 |
| F-2016 epoxy oligomer | 4.4 | 8.8 |
| NMP | 43.6 | 87.2 |
| THF | 10 | 20 |
| EtOH | 20 | 40 |

NMP = N-Methyl-2-pyrrolidone; THF = Tetrahydrofuran; EtOH = Ethanol

### Example 2

In Example 2, the precursor fibers were prepared in the same way as Example 1. The fibers were pre-crosslinked prior to pyrolysis heating to a temperature below the pyrolysis temperature, but above 250° C. (pretreatment). The crosslinking was done in argon atmosphere with 200 sccm flow rate. The furnace was pre-heated to 70° C., then heated to 250° C. at 10° C./min, then 1° C./min to 300° C., and soaked at 300° C. for 1 hour. The fibers were cooled to below 50° C. after the heating was completed.

The preheated fibers were then pyrolyzed using the same 675° C. protocol used in Comparative Example 1 and Example 1. The resultant fibers were tested for hydrogen/ethylene separation. The permeance and selectivity results are shown in Table 3.

TABLE 3
Permeation results of CMS fibers

| | | (P/l)_{H2} | |
|---|---|---|---|
| Examples | Samples | (GPU) | α_{(H2/C2H4)} |
| Comparative 1 | no Br, no pretreatment | 56 ± 6 | 114 ± 12 |
| Example 1 | with Br, no pretreatment | 89 ± 9 | 138 ± 14 |
| Example 2 | with Br, 300 C pretreatment | 102 | 138 ± 6 |
| | (Argon, 1 hr) | | |

### Examples 3-6

The polymeric fibers (with cross-linking agent) obtained in Example 1 were crosslinked under different temperatures prior to pyrolysis. The pre-treatment was done in argon with 200 a sccm flow rate. The furnace was pre-heated to 70° C., then heated to Tmax−50° C. at 10° C./min, then 1° C./min to Tmax ° C., and soak at Tmax ° C. for 1 hour. The fibers were cooled to below 50° C. after the heating is completed. The resultant crosslinked fibers were pyrolyzed under the same 675° C. protocol. The measured skin thickness by SEM were listed in Table 4. From Table 4, it can be seen that too low or too high crosslinking temperature may result in increased skin thickness in CMS fibers.

TABLE 4
Skin thickness of CMS prepared under different crosslinking conditions

| Examples | Sample description | Skin thickness |
|---|---|---|
| Comparative Example 1 | No Br, no crosslinking | 14.0 ± 0.8 |
| Example 1 | Br, no pre-treatment | 6.5 ± 0.6 |
| Example 2 | 300° C./1 hr pre-treatment | 5.9 ± 0.1 |
| Example 3 | 325° C./1 hr pre-treatment | 4.0 ± 0.7 |
| Example 4 | 350° C./1 hr pre-treatment | 3.8 ± 0.3 |
| Example 5 | 375° C./1 hr pre-treatment | 7.6 ± 0.6 |
| Example 6 | 400° C./1 hr pre-treatment | 10.4 ± 0.3 |

The amount of bromine in the CMS hollow fibers of Example 1 was determined using neutron activation analysis as follows. Five aliquots CMS fibers were prepared by transferring appropriate amounts ranging from 0.04 to 0.3 grams of the fibers into pre-cleaned 2-dram polyethylene vials. A blank sample of water, 6 mL, was also prepared into a 2-dram vial. Standards of bromine were prepared from a NIST traceable 1,000 ug/mL SPEX CertiPrep bromine standard solution by transferring 0.1 and 0.15 mL of the solution into 2-dram vials. The standard was diluted to the same volume as the samples using milli-Q pure water and the vials were heat-sealed. The aliquots, standards and the blank were then analyzed for bromine. Specifically, three of the aliquots were irradiated for 10 minutes at 30 kW reactor power. After waiting for 5 hours, the gamma-spectroscopy was carried out for 7200 seconds each. Two of the samples were irradiated for 2 minutes at 100 kW reactor power using a pneumatic transfer system. After waiting for 6 minutes the samples were counted for 270 seconds. The bromine concentrations were calculated using CANBERRA™ software and standard comparative technique using these spectra. Shown in Table 5 are the final results, listed is an average of the 5 values of bromine along with the minimum and maximum measured values.

TABLE 5

| | | Br, ppm | | |
|---|---|---|---|---|
| Example | Description | Average | Minimum | Maximum |
| #1 | CMS Hollow | 580 ± 30 | 420 ± 20 | 700 ± 40 |
| | Fibers | | | |

1. A cross-linked polyimide comprising, the reaction product of a crosslinking agent and a polyimide, wherein the cross-linking agent is comprised of at least two cross-linking moieties and the polyimide is comprised of two or more polyimide chains having an aryl constituent having a moiety comprised of a reactive substituent such that the polyimide chains are cross-linked through the cross-linking agent by cross-linking chemical bonds from the reaction of the reactive substituent of the aryl constituents of the polyimide chains and the cross-linking moieties of the cross-linking agent.

2. The cross-linked polyimide of claim 1, wherein the cross-linking moities of the cross-linking agent is Br or carboxylic acid.

3. The cross-linked polyimide any of the preceding claims, wherein the cross-linking agent has a molecular weight of at least 700 to 40,000.

4. The cross-linked polyimide any of the preceding claims, wherein the reactive substituent is a reactive hydrogen or halogen and the moiety of the aryl substituent of the polyimide is an alkyl, amino, amide, ether, carboxylic acid, hydroxyl, or combination thereof.

5. The cross-linked polyimide any of the preceding claims, wherein the aryl constituent is a benzene ring and the aryl moiety is a methyl.

6. The cross-linked polyimide any of the preceding claims, wherein the cross-linking chemical bonds fail to undergo rescission prior to decomposition of the polyimide under an inert atmosphere.

7. The cross-linked polyimide of claim 6, wherein the chemical bonds fail to undergo rescission prior to 400° C.

8. The cross-linked polyimide any of the preceding claims, wherein the cross-linking agent is a halogenated aromatic epoxide.

9. The cross-linked polyimide any of the preceding claims, wherein the cross-linking agent is a halogenated aromatic compound of an oligomeric or polymeric residue of the following compound having a formula: 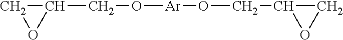
where Ar represents a divalent aromatic group of the form: 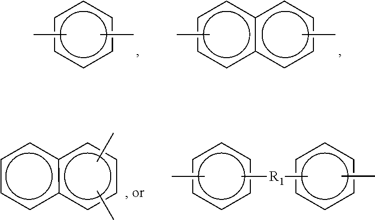
Where R₁ is a direct bond or anyone of the following divalent radicals: 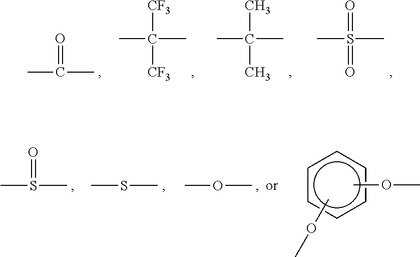
where the oligomeric or polymeric residue has at least two halogens in total substituted on Ar present in said oligomeric or polymeric residue.

10. The cross-linked polyimide any of the preceding claims, wherein the polyimide is an aromatic polyimide that is the reaction product of a dianhydride and amine.

11. The cross-linked polyimide claim 10, wherein the polyimide is formed from a diamine that has an active hydrogen moiety substituted on an aryl after formation of the polyimide.

12. The cross-linked polyimide of claim 11, wherein the polyimide is comprised of at least one of the following diamines: 2,4,6-trimethyl-1,3-phenylenediamine (DAM), 3,5-diaminobenzoic acid (DABA), 2,3,5,6-tetramethyl-1,4-phenylenediamine (durene), or tetramethylmethylenedianiline (TMMDA).

13. A method of forming a cross-linked polyimide comprising,
(i) mixing a cross-linking agent comprised of a plurality of cross-linking moieties and a polyimide that is comprised of a plurality of polyimide chains having an aryl constituent having a moiety comprised of a reactive substituent to form a mixture and
(ii) heating the mixture to a cross-linking temperature that is greater than 150° C. to a pyrolysis temperature, which is a temperature where the polyimide begins to decompose and form carbon, to react the reactive substituent with the cross-linking moiety to form the cross-linked polyimide.

14. The method of claim 13, wherein the pyrolysis temperature is from 400° C. to 450° C.

15. The method of either 13 or 14, wherein the cross-linking temperature is at least 250° C.

16. The method of any one of claims 13 to 15, wherein the cross-linking temperature is at least 300° C. to 375° C. and the cross-linking temperature is held at that temperature for a cross-linking hold time of 15 minutes to 5 hours.

17. The method any one of claims 13 to 16, wherein the cross-linking moieties of the cross-linking agent is bromine.

18. The method of any one of claims 13 to 16, wherein the polyimide is a copolymer of 3,3′,4,4′-benzo-phenonetetracarboxylic acid dianhydride and 5(6)-amino-1-(4′-aminophenyl)-1,3,3-trimethylindane; or one of the following polyimides represented by:

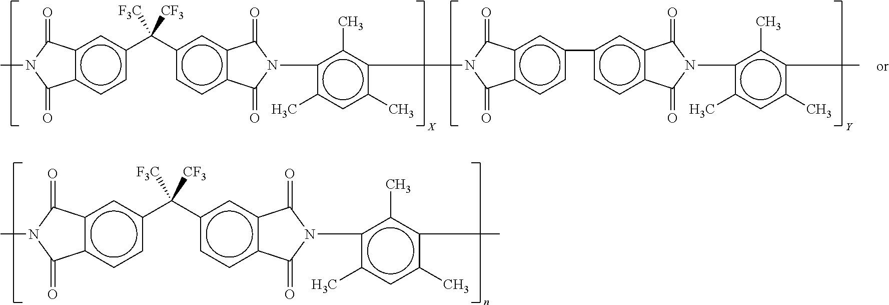

19. The method of any one of claims 13-18, wherein the polyimide is represented by: 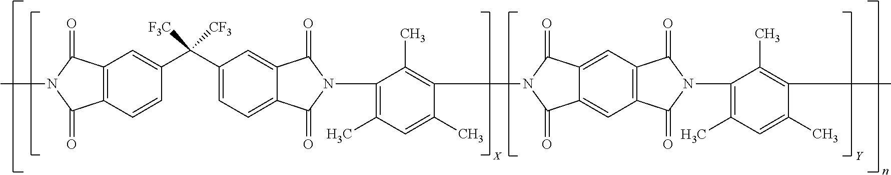
where X is 0.1 to 0.9 and Y is 0.1 to 0.9 and X+Y=1 and n is an integer that may be any that realizes a molecular weight of 30 to 200 kDa.

20. The method of claim 19, wherein X is 0.1 to 0.35 and Y is 0.65 to 0.9.

21. The method of any one of claims 13-20, wherein the mixing is performed by dissolving the polyimide and cross-linking agent in a solvent to form a dope solution that is formed into a shape and then removing the solvent.

22. The method of claim 21, wherein the shape is a hollow fiber.

23. A method of forming a carbon molecular sieve membrane comprising, heating the cross-linked polyimide of any one of the preceding claims to a pyrolysis temperature of 450° C. to 1200° C. for a time or at least 15 minutes to 72 hours under a nonoxiding atmosphere.

24. The method of claim 23, wherein the carbon molecular sieve membrane has a halogen concentration of 10 parts per million to 2000 parts per million by weight of the carbon molecular sieve membrane.

25. The method of claim 24, wherein the halogen concentration is 50 parts per million to 1000 parts per million.

26. The method of any one of claims 13-24, wherein the reactive substituent is a hydrogen in a methyl group substituted on the aryl.

27. A carbon molecular sieve membrane, comprised of carbon and a halogen, wherein the halogen is present at a concentration of 10 parts per million to 2000 parts per million by weight of the carbon molecular sieve membrane.

28. The carbon molecular sieve membrane of claim 27, wherein the carbon molecular sieve is a hollow fiber.

29. The carbon molecular sieve membrane of claim 27 or 28, wherein the halogen is Br.
